(19) United States
(12) Patent Application Publication
(10) Pub. No.: US 2025/0387891 A1
(43) Pub. Date: Dec. 25, 2025

(54) WORKING MACHINE

(71) Applicant: KOKI HOLDINGS CO., LTD., Tokyo (JP)

(72) Inventor: Takeshi SAITOU, Ibaraki (JP)

(21) Appl. No.: 18/877,853

(22) PCT Filed: May 26, 2023
(86) PCT No.: PCT/JP2023/019612

§ 371 Date: Dec. 20, 2024

(30) Foreign Application Priority Data
Jun. 30, 2022 (JP) 2022-106280

(51) Int. Cl. B25C 5/13; B25C 5/15; B25C 5/16

(52) U.S. Cl. CPC B25C 5/13; B25C 5/15; B25C 5/1606

(57) ABSTRACT

A fastener driving machine according to one embodiment includes an ejection unit housing a fastener, and a driver blade configured to strike the fastener housed in the ejection unit. The ejection unit has a blade guide forming one side of an ejection path to which the fastener is supplied, a guide plate facing the blade guide and forming the other side of the ejection path, and a raised portion provided on the blade guide. The driver blade includes a recessed portion configured to receive the raised portion. The raised portion is positioned at the side of the fastener supplied to the ejection path, and suppresses entirety or part of the fastener from coming off the ejection path.

### CROSS-REFERENCE TO RELATED APPLICATIONS

This application is the U.S. National Phase under 35 U.S.C. § 371 of International Application No. PCT/JP2023/019612, filed on May 26, 2023, which claims the benefit of foreign priority to Japanese Patent Application No. 2022-106280 filed on Jun. 30, 2022, the entire contents of each of which are hereby incorporated by reference.

### TECHNICAL FIELD

The present invention relates to a working machine suitable for a work of fixing or joining an opponent member.

### BACKGROUND ART

As one example of the working machine as described above, a fastener driving machine that drives a fastener into an opponent member has been known. Patent Literature 1 describes a fastener driving machine having a nose portion forming an ejection path and a driver blade reciprocating in the ejection path. The fastener is supplied to the ejection path formed by the nose portion. The fastener supplied to the ejection path is struck by the driver blade and driven into the opponent member.

### CITATION LIST

### Patent Literature

Patent Literature 1: JP-A-2018-34258

### SUMMARY OF INVENTION

### Technical Problem

Since the driver blade reciprocates in the ejection path formed by the nose portion, it is necessary to avoid contact (interference) between the nose portion and the driver blade. As a result, e.g., the shape of the nose portion is limited, which may lead to insufficient positioning of the fastener in the ejection path. In this case, the fastener may be inclined or deformed by impact at the time of striking, and driving accuracy may lower.

On the other hand, if, e.g., a restriction unit that prevents the inclination or deformation of the fastener is provided at the nose portion, the driver blade may be elongated in order to avoid contact (interference) between the restriction unit and the driver blade. Further, there is a possibility that the entire working machine is increased in size due to an increase in the length of the driver blade.

An object of the present invention is to improve driving accuracy of a working machine while avoiding an increase in the size of the working machine.

### Solution to Problem

A fastener driving machine according to one embodiment includes an ejection unit housing a fastener, and a striking unit capable of reciprocating in a first direction and a second direction opposite to the first direction and configured to move in the first direction to strike the fastener housed in the ejection unit. The ejection unit has a first wall portion forming one side of an ejection path to which the fastener is supplied, a second wall portion facing the first wall portion and forming the other side of the ejection path, and a raised portion provided on at least one of the first wall portion or the second wall portion. The striking unit has a recessed portion configured to receive the raised portion. The raised portion is positioned at the side of the fastener supplied to the ejection path, and suppresses entirety or part of the fastener from coming off the ejection path. An end of the raised portion on a second direction side is positioned at the second direction side of an end of the fastener on a second direction side.

### Advantageous Effects of Invention

According to the present invention, the driving accuracy of the working machine can be improved while the increase in the size of the working machine is avoided.

### BRIEF DESCRIPTION OF DRAWINGS

FIG. 1 is a left side view of a fastener driving machine.

FIG. 2 is a front view of the fastener driving machine.

FIG. 3 is a sectional view of the fastener driving machine.

FIG. 4 is another sectional view of the fastener driving machine.

FIG. 5A is a front perspective view of a driver blade.

FIG. 5B is a back perspective view of the driver blade.

FIG. 6 is an enlarged perspective view of an ejection unit.

FIG. 7A is an enlarged perspective view of a blade guide.

FIG. 7B is an enlarged perspective view of a guide plate.

FIG. 8 is a sectional view showing the ejection unit when the driver blade is at a standby position.

FIG. 9 is a sectional view showing the ejection unit when the driver blade is at a top dead center.

FIG. 10 is a sectional view showing the ejection unit when the driver blade is at a bottom dead center.

FIG. 11 is a partially-enlarged sectional view taken along line C-C in FIG. 9.

FIG. 12 is a partially-enlarged sectional view taken along line D-D in FIG. 10.

FIG. 13 is a partially-enlarged sectional view showing another example of the embodiment.

FIG. 14 is a partially-enlarged sectional view showing still another example of the embodiment.

### DESCRIPTION OF EMBODIMENTS

### First Embodiment

Hereinafter, one embodiment of the present invention will be described in detail with reference to the drawings. Note that in all the drawings referred to for describing the embodiment, the same or substantially the same configurations and elements are denoted by the same reference numerals. In addition, in principle, repeated description of configurations and components once described will be omitted.

### Outline of Fastener Driving Machine

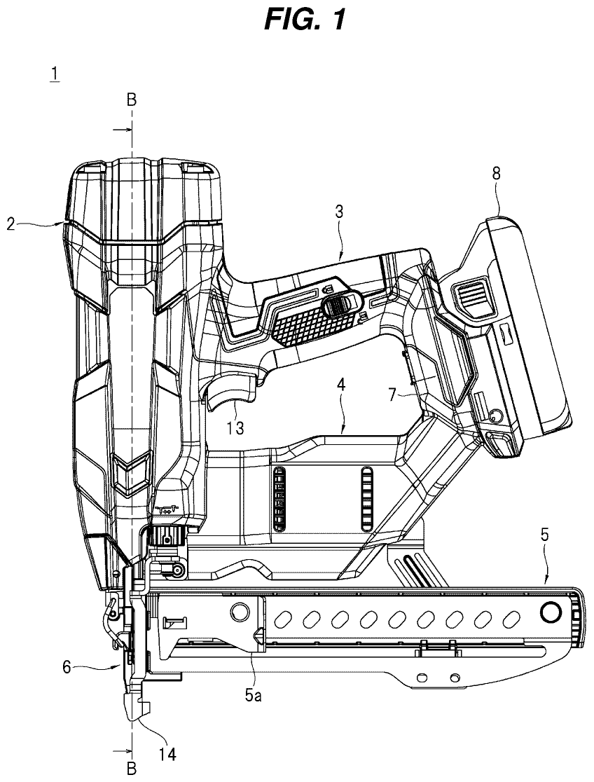

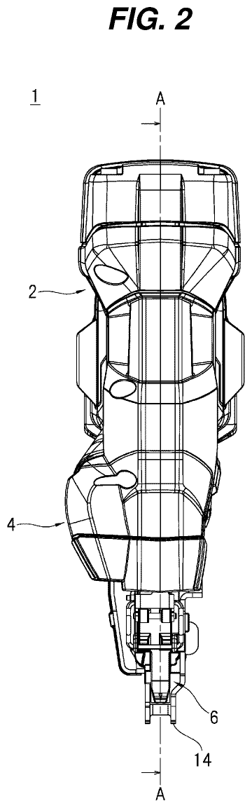

A working machine according to the present embodiment is a fastener driving machine suitable for a work of fixing or joining an opponent member. FIG. 1 is a left side view of a fastener driving machine 1 according to the present embodiment. FIG. 2 is a front view of the fastener driving machine 1 according to the present embodiment.

The fastener driving machine 1 includes a cylinder housing 2, a handle 3, a motor housing 4, a magazine 5, and an ejection unit 6. The cylinder housing 2 has a substantially tubular shape as a whole. The handle 3 and the motor housing 4 extend in a direction crossing the cylinder housing 2, and one end side thereof is connected to the cylinder housing 2. On the other hand, the other end side of the handle 3 and the motor housing 4 is connected to a connection portion 7. From another point of view, the back ends of the handle 3 and the motor housing 4 are coupled to each other via the connection portion 7.

A battery attachment portion to and from which a battery 8 is attachable and detachable is provided on the back surface of the connection portion 7. The battery 8 is a power source of an electric motor 30 to be described later. The type of battery 8 is not particularly limited, but the battery 8 in the present embodiment is a lithium ion battery. Other examples of the battery 8 include a nickel hydrogen battery, a lithium ion polymer battery, and a nickel cadmium battery.

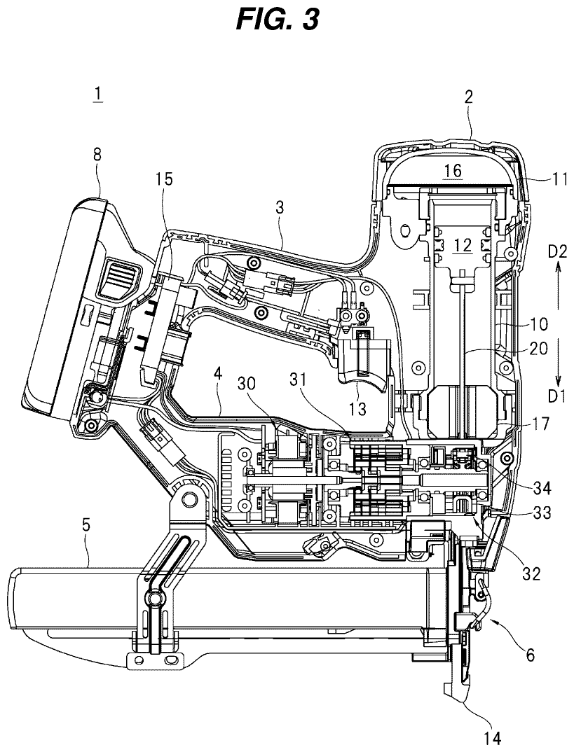

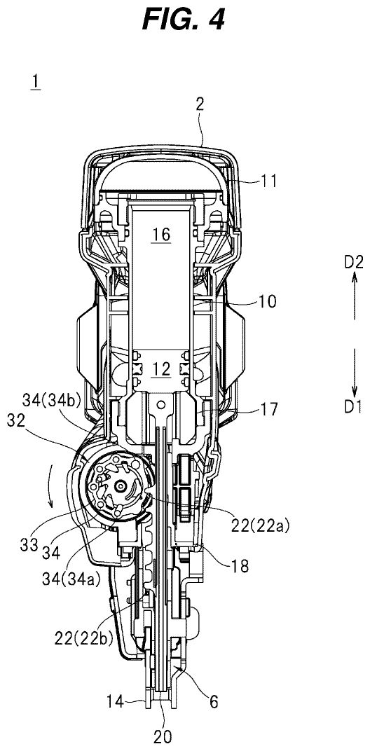

FIGS. 3 and 4 are sectional views of the fastener driving machine 1. Note that the section shown in FIG. 3 is a section taken along line A-A in FIG. 2. The section shown in FIG. 4 is a section taken along line B-B in FIG. 1.

A cylinder 10 and an accumulator container 11 are housed in the cylinder housing 2, and a piston 12 is housed in the cylinder 10. The piston 12 can reciprocate in the center line direction of the cylinder 10 in the cylinder 10.

The electric motor 30 and a speed reduction mechanism 31 are housed in the motor housing 4. A trigger 13 is provided on the handle 3, and a push lever 14 is provided adjacent to the ejection unit 6. Further, a control unit (control board) 15 is housed in the connection portion 7.

When a predetermined operation is executed in a state of a predetermined condition being satisfied, the control unit 15 causes the battery 8 to supply electric power to the electric motor 30 to operate the electric motor 30. For example, when the trigger 13 is operated in a state of the push lever 14 being pressed against the opponent member, electric power is supplied to the electric motor 30, and the electric motor 30 is operated accordingly. The output (drive force) of the electric motor 30 is transmitted to a driver blade 20 fixed to the piston 12 via the speed reduction mechanism 31 and a power transmission mechanism 32.

The magazine 5 is disposed below the motor housing 4. One end side of the magazine 5 in the longitudinal direction thereof is connected to the ejection unit 6, and the other end side of the magazine 5 in the longitudinal direction thereof is connected to the motor housing 4.

The magazine 5 houses a plurality of fasteners arranged in line, and supplies the housed fasteners to the ejection unit 6. More specifically, the magazine 5 includes a feeder 5a (FIG. 1) that supplies the plurality of housed fasteners to the ejection unit 6 one by one.

The ejection unit 6 is disposed below the cylinder housing 2 and in front of the magazine 5. The ejection unit 6 temporarily houses the fastener supplied from the magazine 5. From another point of view, the fasteners are sequentially fed from the magazine 5 to the ejection unit 6.

The driver blade 20 reciprocates in a predetermined direction to strike the fastener housed in the ejection unit 6 and drive the fastener into the opponent member. From another point of view, the driver blade 20 reciprocates in the predetermined direction to drive the fastener out of the ejection unit 6. That is, the driver blade 20 is one example of a striking unit of the present invention. When the fastener is driven out of the ejection unit 6 by the driver blade 20, the feeder 5a in the magazine 5 feeds the next fastener to the ejection unit 6.

### Cylinder and Accumulator Container

The cylinder 10 and the accumulator container 11 communicate with each other to form a pressure chamber 16. The pressure chamber 16 is filled with compressed fluid. The type of fluid to be charged in the pressure chamber 16 is not particularly limited, but the fluid in the present embodiment is air. Other examples of the fluid to be charged in the pressure chamber 16 include inert gas such as nitrogen gas or rare gas.

The air charged in the pressure chamber 16 is one of drive sources that move the piston 12 and the driver blade 20 in a predetermined direction. The drive of the piston 12 and the driver blade 20 by the air charged in the pressure chamber 16 will be described later again.

### Piston and Driver Blade

As described above, the piston 12 can reciprocate in the center line direction of the cylinder 10. From another point of view, the piston 12 can reciprocate in a first direction D1 away from the accumulator container 11 and a second direction D2 toward the accumulator container 11.

The driver blade 20 is integrated with the piston 12, and reciprocates together with the piston 12. That is, the driver blade 20 reciprocates in the first direction D1 away from the accumulator container 11 and the second direction D2 toward the accumulator container 11. The driver blade 20 moves in the first direction D1 to strike the fastener housed in the ejection unit 6.

In the following description, the movement direction of the piston 12 and the driver blade 20 will be defined as an up-down direction. Thus, in the following description, movement of the piston 12 or the driver blade 20 in the first direction D1 may be referred to as “lowering.” Moreover, movement of the piston 12 or the driver blade 20 in the second direction D2 may be referred to as “lifting.”

### Trigger and Push Lever

The push lever 14 is constantly biased downward (in the first direction D1) by an elastic member (for example, coil spring). When the tip end of the push lever 14 is pressed against the opponent member, the push lever 14 is lifted against the biasing of the elastic member. When the push lever 14 is lifted to a predetermined position, a push lever switch is operated, and a signal (push lever signal) is input to the control unit 15 accordingly.

When the trigger 13 is operated, a trigger switch is operated, and a signal (trigger signal) is input to the control unit 15 accordingly. The input of the push lever signal and the trigger signal is one predetermined condition for the control unit 15 to supply electric power to the electric motor 30. When the trigger signal is input with the push lever signal input, the control unit 15 supplies electric power to the electric motor 30.

### Details of Driver Blade

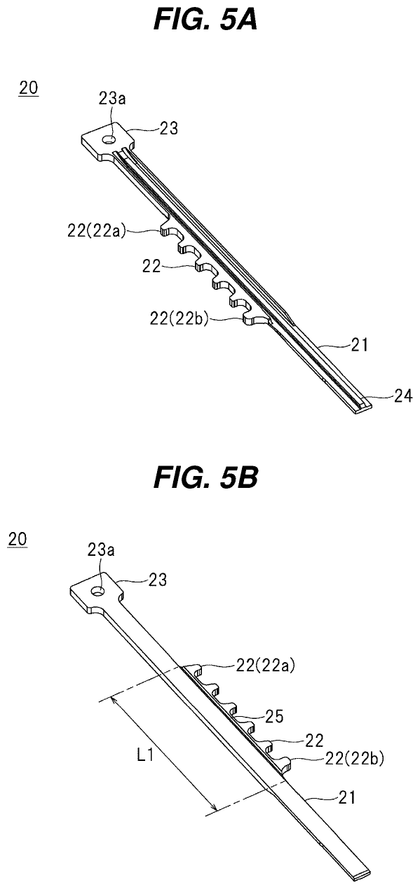

FIG. 5A is a front perspective view of the driver blade 20, and FIG. 5B is a back perspective view of the driver blade 20. The driver blade 20 is a rod-shaped metal member having a body portion 21, a plurality of rack portions 22, and a fixing portion 23.

The body portion 21 has an elongated shape extending in the center line direction of the cylinder 10. The fixing portion 23 is provided at one end (upper end) of the body portion 21 in the longitudinal direction thereof, and is fixed to the piston 12. More specifically, the fixing portion 23 is formed with a through-hole 23a into which a fixing pin is to be inserted, and both ends of the fixing pin inserted into the through-hole 23a are supported by the piston 12.

The rack portions 22 are provided on one side of the driver blade 20. More specifically, six rack portions 22 protruding in the same direction with respect to the body portion 21 are provided on one side of the body portion 21. These rack portions 22 are arranged in line along the longitudinal direction of the body portion 21.

In the following description, the rack portion 22 closest to the fixing portion 23 in the longitudinal direction of the body portion 21 may be referred to as an “upper end rack portion 22a,” and the rack portion 22 farthest from the fixing portion 23 may be referred to as a “lower end rack portion 22b” in order to distinguish these rack portions 22a, 22b from other rack portions 22. In short, four rack portions 22 are arranged at equal intervals between the upper end rack portion 22a and the lower end rack portion 22b.

A guide protrusion 24 is formed on the front surface of the driver blade 20. More specifically, the guide protrusion 24 is formed on the front surface of the body portion 21. The guide protrusion 24 is provided at the center or substantially the center of the body portion 21 in the width direction thereof, and extends in the longitudinal direction of the body portion 21.

A recessed portion 25 is formed in the back surface of the driver blade 20. More specifically, the recessed portion 25 is provided between the body portion 21 and the rack portions 22, and extends in the arrangement direction of the rack portions 22 (=the longitudinal direction of the body portion 21). The recessed portion 25 extends from the lower end rack portion 22b to the upper end rack portion 22a, and both ends thereof in the longitudinal direction are opened.

From another point of view, the recessed portion 25 is a groove provided in the back surface of the driver blade 20. Although the recessed portion 25 of the present embodiment is formed by cutting the back surface of the driver blade 20, the recessed portion 25 may be formed by a method other than cutting (for example, pressing).

### Electric Motor and Speed Reduction Mechanism

Refer to FIGS. 3 and 4 again. The electric motor 30 is a DC brushless motor including, e.g., a stator, a rotor, and a coil. The speed reduction mechanism 31 is a planetary gear multistage speed reduction mechanism to which rotational drive force output from the electric motor 30 is input. The speed reduction mechanism 31 reduces the speed of the input rotational drive force, increases torque, and outputs the increased torque.

### Power Transmission Mechanism

The power transmission mechanism 32 includes a wheel 33 to which the output of the speed reduction mechanism 31 is input, a plurality of pins 34 provided in the wheel 33, etc. The wheel 33 is provided with eight pins 34 along the rotation direction of the wheel 33. From another point of view, the eight pins 34 are arranged on the circumference of a circle centered on the rotation center of the wheel 33.

Note that among the eight pins 34, the pin 34b on one end side in the arrangement direction is thicker than the other pins 34. In the following description, the pin 34b may be referred to as a “terminal pin 34b,” and the pin 34 farthest from the terminal pin 34b in the arrangement direction may be referred to as a “start pin 34a” in order to distinguish these pins from the other pins 34. In short, six pins 34 are arranged at equal intervals between the start pin 34a and the terminal pin 34b.

The wheel 33 rotates counterclockwise in FIG. 4. When the wheel 33 rotates, the plurality of pins 34 sequentially engages with the plurality of rack portions 22 provided in the driver blade 20. Specifically, the start pin 34a first engages with the upper end rack portion 22a. Thereafter, the plurality of pins 34 sequentially engages with the plurality of rack portions 22. As a result, the rotation force of the wheel 33 is transmitted to the driver blade 20, and the driver blade 20 and the piston 12 move in the second direction D2. That is, the piston 12 and the driver blade 20 are lifted.

When the piston 12 and the driver blade 20 are lifted, the air charged in the pressure chamber 16 is compressed, and the internal pressure of the pressure chamber 16 increases. From another point of view, an air spring is compressed. Thereafter, when the engagement between the terminal pin 34b and the lower end rack portion 22b is released, the rotation force of the wheel 33 is not transmitted to the driver blade 20. As a result, the piston 12 and the driver blade 20 move in the first direction D1 by the pressure of the air in the pressure chamber 16. That is, the piston 12 and the driver blade 20 are lowered.

### Top Dead Center and Bottom Dead Center

The driver blade 20 reciprocating in the first direction D1 and the second direction D2 together with the piston 12 reciprocates between a bottom dead center which is an end of a movement stroke on the first direction D1 side and a top dead center which is an end of the movement stroke on the second direction D2 side. Note that the movement stroke of the driver blade 20 in the present embodiment is 62 mm.

The piston 12 moving in the first direction D1 collides with a bumper 17 disposed at the lower end of the cylinder 10, and stops accordingly. That is, the position (position shown in FIG. 4) of the piston 12 in contact with the bumper 17 is the bottom dead center of the piston 12. When the piston 12 reaches the bottom dead center, the driver blade 20 moving integrally with the piston 12 also reaches the bottom dead center. That is, the position (position shown in FIG. 4) of the driver blade 20 when the piston 12 is in contact with the bumper 17 is the bottom dead center of the driver blade 20. In other words, the position of the driver blade 20 when the piston 12 is at the bottom dead center is the bottom dead center of the driver blade 20.

On the other hand, when the engagement between the terminal pin 34b and the lower end rack portion 22b is released, the piston 12 moving in the second direction D2 starts lowering toward the bottom dead center. That is, the position of the piston 12 at the moment when the engagement between the terminal pin 34b and the lower end rack portion 22b is released is the top dead center of the piston 12. Then, the driver blade 20 moving integrally with the piston 12 starts lowering toward the bottom dead center at the same time as the piston 12 starting lowering toward the bottom dead center. That is, the position of the driver blade 20 at the moment when the engagement between the terminal pin 34b and the lower end rack portion 22b is released is the top dead center of the driver blade 20. In other words, the position of the driver blade 20 when the piston 12 is at the top dead center is the top dead center of the driver blade 20.

### Ejection Unit

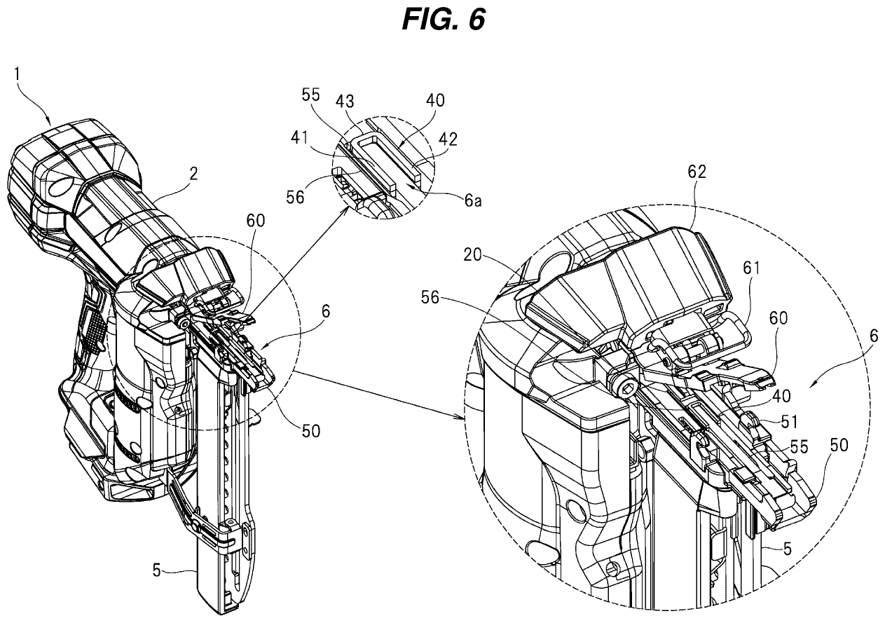

FIG. 6 is an enlarged perspective view of the ejection unit 6. The ejection unit 6 includes a blade guide 50 and a guide plate 60 turnably coupled to the blade guide 50. Note that the ejection unit 6 may also be referred to as a “nose portion.”

The blade guide 50 and the guide plate 60 together form an ejection path 6a through which a fastener 40 is supplied. In the present embodiment, one side of the ejection path 6a is formed by the blade guide 50, and the other side of the ejection path 6a is formed by the guide plate 60.

More specifically, when the guide plate 60 is turned and stacked on the blade guide 50, the ejection path 6a is formed therebetween. From another point of view, when the blade guide 50 and the guide plate 60 face each other, a space to be the ejection path 6a is formed therebetween. That is, in the present embodiment, the blade guide 50 is equivalent to a first wall portion, and the guide plate 60 is equivalent to a second wall portion.

Note that the fastener 40 of the present embodiment has a first foot portion 41, a second foot portion 42, and a head portion 43, and has a substantially U-shaped appearance as a whole. The first foot portion 41 and the second foot portion 42 are paired, and are parallel to each other. The head portion 43 connects one end of the first foot portion 41 and one end of the second foot portion 42 to each other. The fastener 40 may also be referred to as a “staple.”

The blade guide 50 is provided with a pair of locking claws 51, and the guide plate 60 is provided with an annular locking hook 61. After the guide plate 60 has been stacked on the blade guide 50, the locking hook 61 hooked on the locking claws 51 is pulled up, and then the blade guide 50 and the guide plate 60 are fixed to each other accordingly.

The locking hook 61 is pulled up when an operation portion 62 coupled to an upper portion of the locking hook 61 is turned up. On the other hand, when the operation portion 62 is turned down, the locking hook 61 is pushed down, and the engagement of the locking hook 61 with the locking claws 51 is released.

### Blade Guide

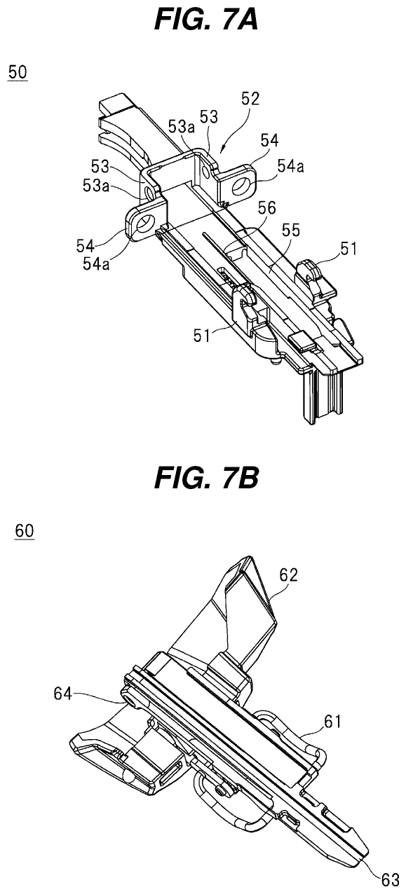

FIG. 7A is an enlarged perspective view of the blade guide 50. A coupling portion 52 is integrally formed with an upper portion of the blade guide 50. The coupling portion 52 includes a pair of opposing side wall portions 53 and flange portions 54 extending outward from the lower ends of the side wall portions 53.

Each side wall portion 53 is provided with a coupling hole 53a, and each flange portion 54 is provided with a bolt hole 54a. The blade guide 50 is fixed to a holder 18 (FIG. 4) with bolts inserted into the bolt holes 54a of the flange portions 54.

The blade guide 50 is further provided with a substantially rectangular opening 55 communicating with the magazine 5. The opening 55 is provided between the pair of locking claws 51, and has shape and size allowing part of the feeder 5a (FIG. 1) to move in and out of the opening 55. The fastener 40 is fed into the ejection unit 6 through the opening 55, and is housed in the ejection unit 6.

A raised portion 56 protruding toward the guide plate 60 is provided on one side of the opening 55. From another point of view, the raised portion 56 is a rib protruding toward the guide plate 60.

The raised portion 56 extends along the edge of the opening 55. More specifically, one end side (upper end side) of the raised portion 56 extends beyond the opening 55 toward the coupling portion 52 side. The other end side (lower end side) of the raised portion 56 extends to the center or substantially the center of the opening 55 in the longitudinal direction thereof.

As shown in FIG. 6, when the fastener 40 is supplied to the ejection path 6a through the opening 55, the raised portion 56 provided at the edge of the opening 55 is positioned at the side of the fastener 40. More specifically, the raised portion 56 is positioned at the side of the first foot portion 41 of the fastener 40 supplied to the ejection path 6a, and extends parallel or substantially parallel to the first foot portion 41.

### Guide Plate

FIG. 7B is an enlarged perspective view of the guide plate 60. The guide plate 60 is provided with a guide groove 63 in which the guide protrusion 24 (FIG. 5A) provided on the driver blade 20 can be fitted. The guide groove 63 restricts movement of the guide protrusion 24 in a direction crossing the longitudinal direction, and guides the driver blade 20 such that the driver blade 20 is lifted and lowered.

A through-hole 64 is provided in an upper portion of the guide plate 60. When the upper portion of the guide plate 60 is inserted between the two side wall portions 53 of the blade guide 50, the through-hole 64 communicates with each of the coupling holes 53a. The guide plate 60 is turnably coupled to the blade guide 50 with a coupling pin penetrating the coupling holes 53a and the through-hole 64.

### Features of Recessed Portion and Raised Portion

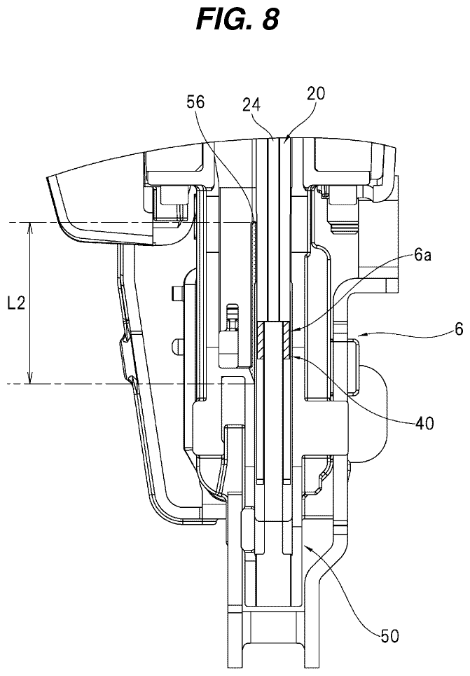

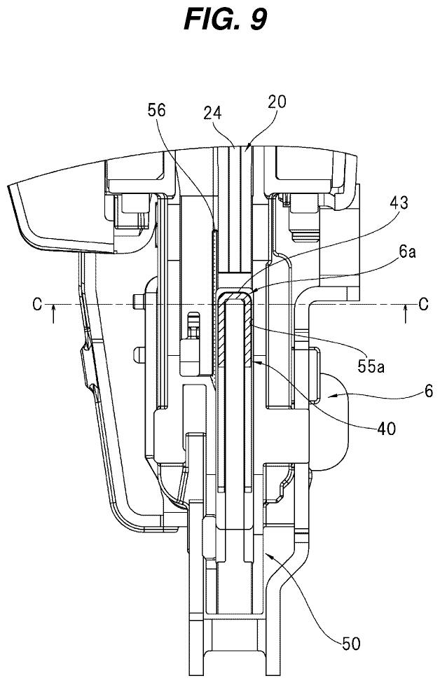

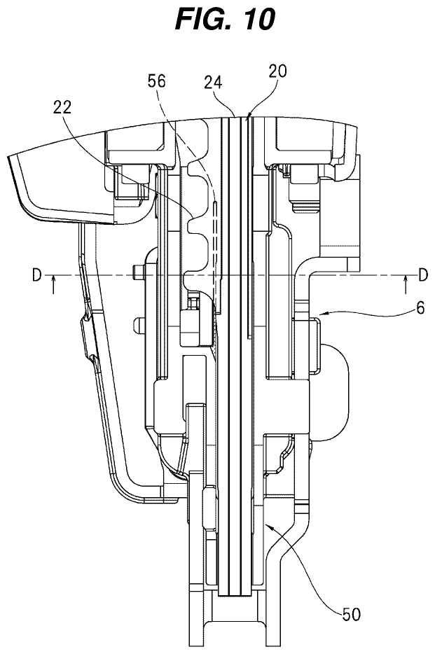

FIG. 8 is a partial sectional view showing the ejection unit 6 when the driver blade 20 is at a standby position. FIG. 9 is a partial sectional view showing the ejection unit 6 when the driver blade 20 is at the top dead center. FIG. 10 is a partial sectional view showing the ejection unit 6 when the driver blade 20 is at the bottom dead center.

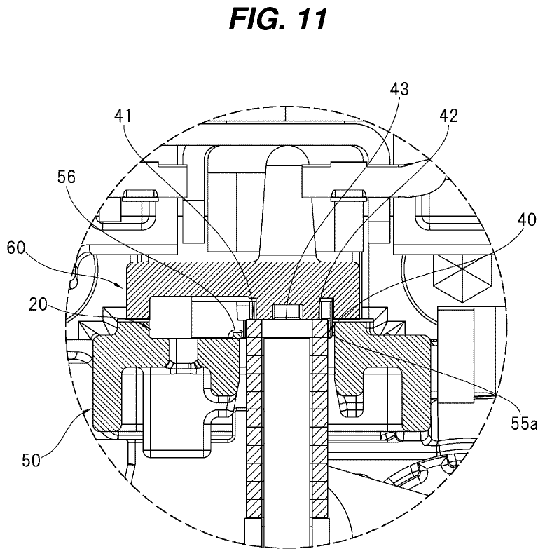

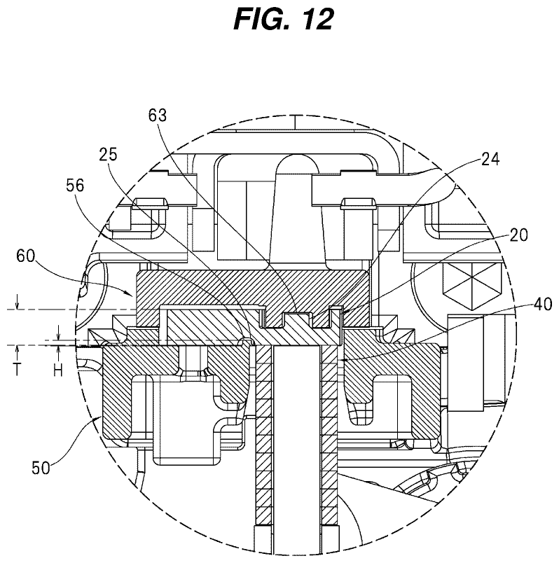

FIG. 11 is a partially-enlarged sectional view taken along line C-C in FIG. 9, and FIG. 12 is a partially-enlarged sectional view taken along line D-D in FIG. 10.

Note that the standby position is a position between the top dead center and the bottom dead center. After the driving operation has been completed, the control unit 15 (FIG. 3) causes the driver blade 20 to lift from the bottom dead center to the standby position, and then, stops the electric motor 30.

As shown in FIG. 8, when the driver blade 20 is at the standby position, the tip end of the driver blade 20 is positioned lower than the head portion 43 of the fastener 40. From another point of view, the driver blade 20 at the standby position partially closes the inlet of the ejection path 6a. As a result, the supply of the fastener 40 to the ejection path 6a is restricted.

As shown in FIG. 9, when the driver blade 20 moves from the standby position toward the top dead center and the tip end of the driver blade 20 moves to a position higher than the head portion 43 of the fastener 40, the restriction of the supply of the fastener 40 is released. Thereafter, the fastener 40 is supplied to the ejection path 6a by the feeder 5a.

As described above, when the fastener 40 is supplied to the ejection path 6a, the raised portion 56 provided in the blade guide 50 is positioned at the side of the fastener 40. More specifically, as shown in FIG. 11, the raised portion 56 is positioned at the side of the first foot portion 41 of the fastener 40.

Thereafter, the driver blade 20 moves from the top dead center toward the bottom dead center, and strikes the fastener 40 in the ejection path 6a. At this time, the raised portion 56 is present at the side of the fastener 40. As a result, inclination or deformation of the fastener 40 toward the raised portion 56 side due to impact of the striking are restricted. That is, the raised portion 56 suppresses the entirety or part of the fastener 40 from protruding to the outside of the ejection path 6a, and driving accuracy is improved.

Note that inclination or deformation of the fastener 40 toward the side opposite to the raised portion 56 side are restricted by the inner surface 55a of the opening 55 positioned at the side of the second foot portion 42.

As shown in FIGS. 10 and 12, the raised portion 56 provided in the blade guide 50 enters the recessed portion 25 provided in the driver blade 20 in a course of lowering the driver blade 20 as described above. In other words, the recessed portion 25 provided in the driver blade 20 receives the raised portion 56 provided in the blade guide 50 in a course of lowering the driver blade 20. From another point of view, the driver blade 20 passes over the raised portion 56 without interfering with the raised portion 56. Thus, movement of the driver blade 20 is not hindered by the raised portion 56 provided in the blade guide 50. That is, the recessed portion 25 prevents interference between the driver blade 20 and the blade guide 50 (raised portion 56).

Here, the raised portion 56 does not enter the recessed portion 25 when the driver blade 20 is at the top dead center (see FIG. 8), and enters the recessed portion 25 in a course of the driver blade 20 moving from the top dead center to the bottom dead center. More specifically, the raised portion 56 enters the recessed portion 25 after the driver blade 20 has passed through the standby position.

When the driver blade 20 is at the bottom dead center, the raised portion 56 has entered the recessed portion 25 halfway in the longitudinal direction of the recessed portion 25. More specifically, when the driver blade 20 is at the bottom dead center, the upper end of the raised portion 56 has not reached the upper end of the recessed portion 25, but is between the second rack portion 22 and the third rack portion 22 from the bottom (see FIG. 10).

From another point of view, the overall length L1 of the recessed portion 25 shown in FIG. 5B is a length by which the upper end of the raised portion 56 does not reach the upper end of the recessed portion 25 even when the driver blade 20 reaches the bottom dead center. From still another point of view, the overall length L2 of the raised portion 56 shown in FIG. 8 is a length by which the upper end of the raised portion 56 does not reach the upper end of the recessed portion 25 even when the driver blade 20 reaches the bottom dead center. Specifically, the overall length L1 of the recessed portion 25 of the present embodiment is 58.0 mm, and the overall length L2 of the raised portion 56 is 25.5 mm. However, even if the length of the raised portion 56 is shorter than 25.5 mm, it is sufficient that the raised portion 56 is positioned at the side of the arrangement area of the fastener 40 shown in FIGS. 8, and L2 is 0.4 mm or more. The overall length L1 of the recessed portion 25 can be appropriately changed as long as the interference between the raised portion 56 and the driver blade 20 can be prevented.

Similarly, as long as the interference between the raised portion 56 and the driver blade 20 can be prevented, the height H of the raised portion 56 shown in FIG. 12 can also be appropriately changed. When the height H of the raised portion 56 is increased, a positioning effect for the fastener 40 is improved.

However, in a case where the height H of the raised portion 56 is increased, the depth of the recessed portion 25 needs to be increased accordingly. However, if the depth of the recessed portion 25 is excessively increased, the strength and durability of the driver blade 20 may be reduced. In view of these circumstances, the height H of the raised portion 56 is preferably within a range of 5% or more and 80% or less of the thickness T of the driver blade 20.

Note that in the present embodiment, the height H of the raised portion 56 is 0.4 mm and the thickness T of the driver blade 20 is 2.5 mm. That is, the height H of the raised portion 56 is 16% of the thickness T of the driver blade 20.

### Other Embodiments

The present invention is not limited to the above-described embodiment, and various changes can be made without departing from the gist thereof. For example, in the above-described embodiment, the raised portion 56 is provided in the blade guide 50. The recessed portion 25 that receives the raised portion 56 is provided in the back surface of the driver blade 20 facing the blade guide 50.

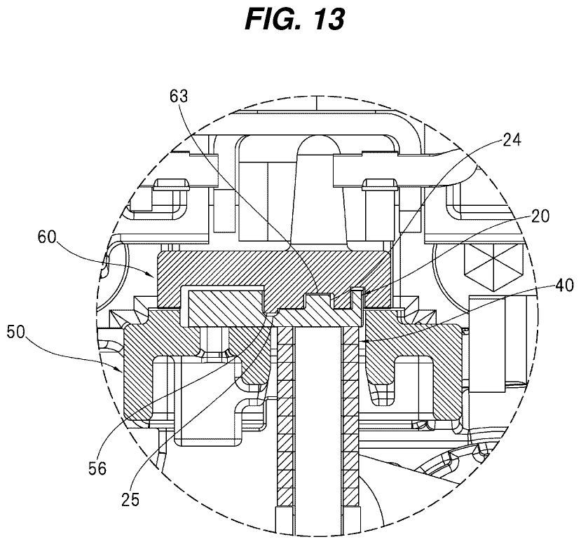

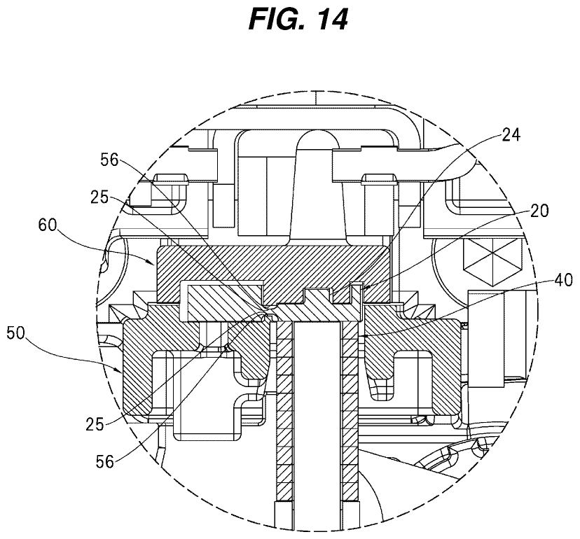

However, as shown in FIG. 13, there is also an embodiment in which the guide plate 60 is provided with the raised portion 56 and the recessed portion 25 is provided in the front surface of the driver blade 20. Moreover, as shown in FIG. 14, there is also an embodiment in which both the blade guide 50 and the guide plate 60 are provided with the raised portion 56 and the recessed portion 25 is provided in both surfaces of the driver blade 20. From these embodiments, it can be understood that the raised portion 56 may be provided only on one of the first wall portion or the second wall portion, or may be provided on both the first wall portion and the second wall portion.

### DESCRIPTION OF REFERENCE SIGNS

1 Fastener Driving Machine
2 Cylinder Housing
3 Handle
4 Motor Housing
5 Magazine
5a Feeder
6 Ejection unit
6a Ejection path
7 Connection Portion
8 Battery
10 Cylinder
11 Accumulator Container
12 Piston
13 Trigger
14 Push Lever
15 Control Unit (Control Board)
16 Pressure Chamber
17 Bumper
18 Holder
20 Driver Blade
21 Body Portion
22 Rack Portion
22a Upper End Rack Portion
22b Lower End Rack Portion
23 Fixing Portion
23a Through-Hole
24 Guide Protrusion
25 Recessed Portion
30 Electric Motor
31 Speed Reduction Mechanism
32 Power Transmission Mechanism
33 Wheel
34 Pin
34a Start Pin
34b Terminal Pin
40 Fastener
41 First Foot Portion
42 Second Foot Portion
43 Head Portion
50 Blade Guide
51 Locking Claw
52 Coupling Portion
53 Side Wall Portion
53a Coupling Hole
54 Flange Portion
54a Bolt Hole
55 Opening
55a Inner Surface
56 Raised Portion
60 Guide Plate
61 Locking Hook
62 Operation Unit
63 Guide Groove
64 Through-Hole
D1 First Direction
D2 Second Direction

1. A working machine comprising:
an ejection unit housing a fastener; and
a striking unit capable of reciprocating in a first direction and a second direction opposite to the first direction and configured to move in the first direction to strike the fastener housed in the ejection unit, wherein
the ejection unit has a first wall portion forming one side of an ejection path to which the fastener is supplied, a second wall portion facing the first wall portion and forming the other side of the ejection path, and a raised portion provided on at least one of the first wall portion or the second wall portion,
the striking unit has a recessed portion configured to receive the raised portion,
the raised portion is positioned at a side of the fastener supplied to the ejection path, and suppresses entirety or part of the fastener from coming off the ejection path, and
an end of the raised portion on a second direction side is positioned at the second direction side of an end of the fastener on the second direction side.

2. The working machine according to claim 1, wherein
the striking unit has an elongated body portion and a plurality of rack portions provided on one side of the body portion,
the plurality of rack portions is arranged in line along a longitudinal direction of the body portion, and
the recessed portion is provided between the body portion and the rack portions, and extends along an arrangement direction of the plurality of rack portions.

3. The working machine according to claim 1, wherein a height of the raised portion is 5% or more and 80% or less of a thickness of the striking unit.

4. The working machine according to claim 1, wherein
the fastener has a first foot portion and a second foot portion parallel to each other, and a head portion connecting one end of the first foot portion and one end of the second foot portion to each other, and
the raised portion is positioned at a side of the first foot portion of the fastener supplied to the ejection path.

5. The working machine according to claim 1, wherein
the striking unit reciprocates between a bottom dead center which is an end of a movement stroke on the first direction side and a top dead center which is an end of the movement stroke on the second direction side,
an end of the striking unit on a first direction side is positioned at the first direction side of an end of the raised portion on the second direction side when the striking unit is at the top dead center.

6. The working machine according to claim 5, wherein when the striking unit is at the bottom dead center, the raised portion enters the recessed portion halfway in a longitudinal direction of the recessed portion.

7. The working machine according to claim 5, wherein
the raised portion enters the recessed portion when the striking unit is at the bottom dead center, and
the raised portion does not enter the recessed portion when the striking unit is at the top dead center.

8. The working machine according to claim 2, wherein
the plurality of lack portions is positioned at only one side of the body portion,
the ejection unit has an inner surface positioned at a side of the body portion opposite to the side with the lack,
the inner surface suppresses entirety or part of the fastener from coming off the ejection path.

9. The working machine according to claim 1, further comprising:
a magazine configured to supply the fastener to the ejection unit,
wherein the first wall portion has an opening communicating with the magazine,
the raised portion is provided on the first wall.

10. A working machine comprising:
an ejection unit housing a fastener; and
a striking unit capable of reciprocating in a first direction and a second direction opposite to the first direction and configured to move in the first direction to strike the fastener housed in the ejection unit,
a magazine configured to supply the fastener to the ejection unit,
wherein the ejection unit has a first wall portion forming one side of an ejection path to which the fastener is supplied and having an opening communicating with the magazine, a second wall portion facing the first wall portion and forming the other side of the ejection path, and a raised portion provided on the first wall portion,
the striking unit has a recessed portion configured to receive the raised portion, and
the raised portion is positioned at a side of the fastener supplied to the ejection path, and suppresses entirety or part of the fastener from coming off the ejection path.

11. A working machine comprising:
an ejection unit housing a fastener; and
a striking unit capable of reciprocating in a first direction and a second direction opposite to the first direction and configured to move in the first direction to strike the fastener housed in the ejection unit,
wherein the ejection unit has a first wall portion forming one side of an ejection path to which the fastener is supplied, a second wall portion facing the first wall portion and forming the other side of the ejection path, and a raised portion provided on at least one of the first wall portion or the second wall portion,
the striking unit has a recessed portion configured to receive the raised portion, and
the raised portion is positioned at a side of the fastener supplied to the ejection path, and suppresses entirety or part of the fastener from coming off the ejection path,
the striking unit has an elongated body portion and a plurality of rack portions provided on only one side of the body portion,
the ejection unit has an inner surface positioned at a side of the body portion opposite to the side with the lack,
the inner surface suppresses entirety or part of the fastener from coming off the ejection path.
